(19) United States
(12) Patent Application Publication
(10) Pub. No.: US 2024/0045175 A1
(43) Pub. Date: Feb. 8, 2024

(54) IMAGING OPTICAL SYSTEM, LENS UNIT AND IMAGING DEVICE

(71) Applicants: Konica Minolta, Inc., Tokyo (CN); KONICA MINOLTA OPTO (DALIAN) CO., LTD., Dalian (JP)

(72) Inventors: Akihiro Kondo, Hino-shi, Tokyo (JP); Zhiyu Huang, Shanghai Songjiang (CN)

(73) Assignees: Konica Minolta, Inc., Tokyo (JP); KONICA MINOLTA OPTO (DALIAN) CO., LTD., Dalian (CN)

(21) Appl. No.: 18/223,140

(22) Filed: Jul. 18, 2023

(30) Foreign Application Priority Data
Jul. 28, 2022 (CN) 202210899228.3

(51) Int. Cl. G02B 9/62; G02B 13/18

(52) U.S. Cl. CPC G02B 9/62; G02B 13/18

(57) ABSTRACT

An imaging optical system includes, in order from an object side, first, second, third, fourth, fifth and sixth lenses. The first lens has negative power and an object side surface having a convex shape. The second lens has positive power and a meniscus shape being convex toward the object side. The third lens has positive power. The fourth lens has negative power. The fifth lens is a biconvex lens that has positive power. The sixth lens has positive or negative power, has an image side surface, and has an extreme value other than an intersection point with an optical axis on the image side surface of the sixth lens. The imaging optical system satisfies a conditional expression (1); 1.5<f2/f<3.5. The f2 represents a focal length of the second lens, and the f represents a focal length of the imaging optical system.

### CROSS-REFERENCE TO RELATED APPLICATIONS

The entire disclosure of Chinese Patent Application No. 202210899228.3 filed on Jul. 28, 2022 is incorporated herein by reference.

### BACKGROUND

### Technical Field

The present invention relates to an imaging optical system, a lens unit and an imaging device.

### Description of Related Art

Chinese Patent Application Laid-Open No. 105204144 and Chinese Patent Application Laid-Open No. 103529538 disclose an imaging optical system configured by six lenses with a relatively wide angle of view.

In the optical system disclosed in Example 4 of Chinese Patent Application Laid-Open No. 105204144, the angle of view is 68.5°, which is wide, but the F-number is 2.43, which is relatively large, and also the total track length with respect to the focal length is relatively long.

In the optical system disclosed in Chinese Patent Application Laid-Open No. 103529538, the F-number is 2.15, which is relatively small, and also the total track length with respect to the focal length is relatively short, but the angle of view is 40.7°, which is relatively narrow.

### SUMMARY

One or more embodiments of the present invention achieve high optical performance and small dimensions while maintaining a small F-number and a wide angle of view.

According to an aspect of the present invention, there is provided an imaging optical system including:
in order from an object side,
a first lens that has negative power and an object side surface having a convex shape;
a second lens that has positive power and a meniscus shape being convex toward the object side;
a third lens that has positive power;
a fourth lens that hays negative power;
a fifth lens that is a biconvex lens having positive power; and
a sixth lens that has positive or negative power, has an image side surface, and has an extreme value other than an intersection point with an optical axis on the image side surface of the sixth lens, wherein
the imaging optical system satisfies the following conditional expression (1):

1.5<f2/f<3.5 (1)
where f2 represents a focal length of the second lens, and f represents a focal length of the imaging optical system.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic sectional view of an imaging device according to one or more embodiments;

FIG. 2 is a block diagram showing a schematic control configuration of the imaging device according to one or more embodiments;

FIG. 3A is a sectional view of an imaging optical system of Example 1;

FIG. 3B shows longitudinal aberrations of the imaging optical system of Example 1;

FIG. 4A is a sectional view of the imaging optical system of Example 2;

FIG. 4B shows longitudinal aberrations of the imaging optical system of Example 2;

FIG. 5A is a sectional view of the imaging optical system of Example 3;

FIG. 5B shows longitudinal aberrations of the imaging optical system of Example 3;

FIG. 6A is a sectional view of the imaging optical system of Example 4; and

FIG. 6B shows longitudinal aberrations of the imaging optical system of Example 4.

### DETAILED DESCRIPTION

Description will hereinafter be given for embodiments of the present invention with reference to drawings. However, the scope of the present invention is not limited to the disclosed embodiments.

[Overall Configuration of Imaging Device]

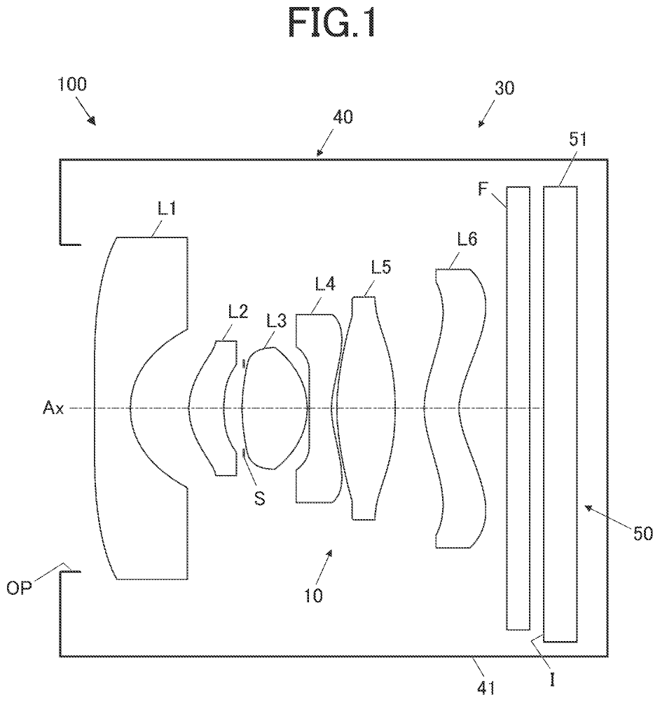

FIG. 1 is a schematic sectional view of an imaging device 100 according to one or more embodiments.

As shown in this figure, the imaging device 100 includes a camera module 30 for forming an image signal.

The camera module 30 includes a lens unit 40 having therein an imaging optical system 10, and a sensor section 50 that converts a subject image formed by the imaging optical system 10 into an image signal.

The lens unit 40 comprises the imaging optical system 10 and a lens barrel 41 in which the imaging optical system 10 is incorporated.

The imaging optical system 10 includes first to sixth lenses L1 to L6 and an optical filter F. Details of a configuration of the imaging optical system 10 will be given later.

The lens barrel 41 is formed of resin, metal, a mixture of resin and glass fiber, or the like, and houses the imaging optical system 10 and the like therein. The lens barrel 41 has an opening OP through which light from the object side enters the lens barrel 41. The lens barrel 41 directly or indirectly holds the first to sixth lenses L1 to L6 and the optical filter F constituting the imaging optical system 10. The lens barrel 41 positions these with respect to the direction of the optical axis Ax of the imaging optical system 10 and the direction perpendicular to the optical axis Ax.

The sensor section 50 includes an imaging element (solid-state image sensor) 51 that detects and photoelectrically converts a subject image formed by the imaging optical system 10.

The imaging element 51 is, for example, a CMOS image sensor. The imaging element 51 is fixed in a state of being positioned with respect to the optical axis Ax. The imaging element 51 has a photoelectric conversion section serving as an imaging surface (image plane) I. A signal processing circuit (not shown) is formed around the photoelectric conversion section. In the photoelectric conversion section, pixels, that is, photoelectric conversion elements, are two dimensionally arranged. Note that the imaging element 51 is not limited to the above-described CMOS image sensor, and hence may be another imaging element, such as a CCD image sensor.

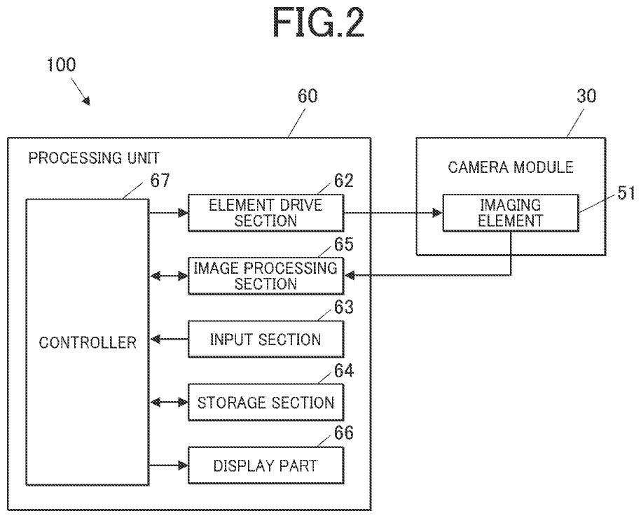

FIG. 2 is a block diagram showing a schematic control configuration of the imaging device 100.

As shown in this figure, the imaging device 100 comprises a processing unit 60 that causes the camera module 30 to operate.

The processing unit 60 comprises an element drive section 62, an input section 63, a storage section 64, an image processing section 65, a display part 66, and a controller 67.

The element drive section 62 receives supply of a voltage or a clock signal for driving the imaging element 51 from the controller 67 and outputs the voltage or the clock signal to a circuit associated with the imaging element 51. Thus, the element drive section 62 causes the imaging element 51 to operate.

The input section 63 receives a user operation or a command from an external device.

The storage section 64 stores information necessary for the operation of the imaging device 100, image data obtained by the camera module 30, lens correction data used for image processing, and the like.

The image processing section 65 performs image processing, such as color correction, tone correction or zooming, on the image signal output from the imaging element 51.

The display part 66 displays information to be presented to a user, a captured image, and the like. Note that the display part 66 can also function as the input section 63.

The controller 67 comprehensively controls operations of the element drive section 62, the input section 63, the storage section 64, the image processing section 65, the display part 66, and the like. The controller 67 performs various kinds of image processing on, for example, the image data obtained by the camera module 30.

[Specific Configuration of Imaging Optical System]

Next, the imaging optical system 10 will be described in more detail.

As shown in FIG. 1, in one or more embodiments, the imaging optical system 10 comprises a first lens L1, a second lens L2, an aperture stop S, a third lens L3, a fourth lens L4, a fifth lens L5, a sixth lens L6, and an optical filter F in this order from the object side.

Among these, the optical filter F is a parallel plate that is assumed, in one or more embodiments, to be an optical low-pass filter, an infrared cut filter, seal glass of the imaging element 51 or the like. Arrangement (provision) of the optical filter F may be omitted by providing its function to one of the lens surfaces configuring the imaging optical system 10. For example, arrangement of the optical filter F may be omitted by providing an infrared cut coating as an infrared cut filter on the surface of at least one lens.

The first lens L1 has negative power (refractive power).

The first lens L1 has a convex surface as its object side surface. Therefore, an incident angle of an off-axis light flux to the object side surface can be made small, so that aberrations that occur on the object side surface can be suppressed and favorable optical performance can be obtained.

The second lens L2 has positive power.

The second lens L2 has a meniscus shape being convex toward the object side. Therefore, the principal point distance can be made shorter than that in a case where the second lens L2 is a biconvex lens. Further, the power of the combined system of the first lens L1 and the second lens L2 becomes small, and aberrations that occur on the first lens L1 and the second lens L2 can be made small.

The third lens L3 has positive power.

The fourth lens L4 has negative power.

The object side surface of each of the third lens L3 and the fourth lens L4 has a convex shape. That is, at least part of the object side surface of each of the third lens L3 and the fourth lens L4 is convex.

The fifth lens L5 has positive power.

The fifth lens L5 is a biconvex lens having convex surfaces on both the object side and the image side. Therefore, the power of the fifth lens L5 can be made relatively strong, and chromatic aberration and the like can be effectively corrected.

The sixth lens L6 has positive or negative power.

The sixth lens L6 has, at least on its image side surface, an extreme value (inflection point) other than an intersection point with the optical axis Ax. The “extreme value” is a point on an aspheric surface, the point where a tangent line of the aspheric surface becomes a line segment perpendicular to the optical axis Ax, in a case of considering a curve of a sectional shape of the sixth lens L6 including, in a surface/plane, the optical axis Ax within an effective radius. Therefore, even in a case where the imaging element 51 needs a large ray incidence angle or needs a non-linear incidence angle characteristic with respect to the image height, the chief ray angle corresponds to the imaging element 51 while the optical performance is maintained.

Further, the imaging optical system 10 satisfies the following conditional expression (1).

1.5<f2/f<3.5 (1)

The “f2” represents the focal length of the second lens L2. The “f” represents the focal length of the entire imaging optical system 10.

The conditional expression (1) is a conditional expression for appropriately setting the focal length of the second lens L2.

If f2/f exceeds the lower limit of the conditional expression (1), the refractive power of the second lens L2 does not become too strong. As a result, it is possible to suppress spherical aberration, coma, axial chromatic aberration and the like that occur on the second lens L2. In addition, it is possible to suppress deterioration in optical performance due to a shape error or an eccentricity error of the second lens L2.

If f2/f falls below the upper limit of the conditional expression (1), the refractive power of the second lens L2 does not become too weak. As a result, it is possible to suppress increase in size of the imaging optical system 10.

Further, the imaging optical system 10 may satisfy the following conditional expression (2).

0.35<CT5/f<0.60 (2)

The “CT5” represents the center thickness (thickness on the optical axis Ax) of the fifth lens L5. The “f” represents the focal length of the entire imaging optical system 10.

The conditional expression (2) is a conditional expression for appropriately setting the thickness of the fifth lens L5 in the axial direction.

If CT5/f falls below the upper limit of the conditional expression (2), the fifth lens L5 does not become too thick. Therefore, it is possible to suppress over field curvature that occurs in a case where the fifth lens L5 becomes thick, and also it is possible to suppress increase in size of the imaging optical system 10.

If CT5/f exceeds the lower limit of the conditional expression (2), the fifth lens L5 does not become too thin. Therefore, it is possible to suppress under field curvature that occurs in a case where the fifth lens L5 becomes thin, and also it is possible to secure the rigidity of the fifth lens L5. Further, the imaging optical system 10 may satisfy the following conditional expression (3).

-1.25<f1/f<−0.30 (3)

The “f1” represents the focal length of the first lens L1. The “f” represents the focal length of the entire imaging optical system 10.

The conditional expression (3) is a conditional expression for appropriately setting the focal length of the first lens L1.

If f1/f falls below the upper limit of the conditional expression (3), the negative refractive power of the first lens L1 does not become strong more than necessary. Therefore, it is possible to reduce coma and distortion in the peripheral portion.

If f1/f exceeds the lower limit of the conditional expression (3), the negative refractive power of the first lens L1 can be appropriately maintained. Therefore, effects in reducing the Petzval sum and correcting field curvature can be obtained.

Further, the imaging optical system 10 may satisfy the following conditional expression (4).

1.5<f5/f<2.5 (4)

The “f5” represents the focal length of the fifth lens L5. The “f” represents the focal length of the entire imaging optical system 10.

The conditional expression (4) is a conditional expression for appropriately setting the focal length of the fifth lens L5.

If f5/f falls below the upper limit of the conditional expression (4), the refractive power of the fifth lens L5 does not become strong more than necessary. Therefore, it is possible to reduce coma and distortion in the peripheral portion.

If f5/f exceeds the lower limit of the conditional expression (4), the refractive power of the fifth lens L5 can be appropriately maintained. Therefore, the total track length does not become too long, and the imaging optical system 10 can be downsized.

Further, the imaging optical system 10 may satisfy the following conditional expression (5).

0.40<r3/r4<0.80 (5)

The “r3” represents the curvature radius of the object side surface of the second lens L2. The “r4” represents the curvature radius of the image side surface of the second lens L2.

The conditional expression (5) is a conditional expression for appropriately setting the ratio of the curvature radii of the object side surface and the image side surface of the second lens L2.

If r3/r4 falls within the range of the conditional expression (5), the refractive index of the second lens L2 can be appropriately set. Therefore, it is possible to prevent increase in size of the imaging optical system 10, and also it is possible to reduce various aberrations and error sensitivity that occur on the second lens L2.

Further, the imaging optical system 10 may satisfy the following conditional expression (6).

−3.0<r10/f<−1.0 (6)

The “r10” represents the curvature radius of the image side surface of the fifth lens L5. The “f” represents the focal length of the entire imaging optical system 10.

The conditional expression (6) is a conditional expression for appropriately setting the curvature radius of the image side surface of the fifth lens L5.

If r10/f falls below the upper limit of the conditional expression (6), the refractive power of the fifth lens L5 does not become strong more than necessary. Therefore, it is possible to reduce coma and distortion in the peripheral portion.

If r10/f exceeds the lower limit of the conditional expression (6), the refractive power of the first lens L1 can be appropriately maintained. Therefore, the total track length does not become too long, and the imaging optical system 10 can be downsized.

Further, the imaging optical system 10 may satisfy the following conditional expression (7).

v3−v4>30.0 (7)

The “v3” represents the Abbe number of the third lens L3. The “v4” represents the Abbe number of the fourth lens L4.

The conditional expression (7) is a conditional expression for appropriately setting the Abbe numbers of the third lens L3 and the fourth lens L4.

If v3-v4 falls within the range of the conditional expression (7), chromatic aberration and field curvature of the entire imaging optical system 10 can be favorably corrected.

As described above, according to one or more embodiments, the first lens L1 has a convex surface as its object side surface. Therefore, an incident angle of an off-axis light flux to the object side surface can be made small, so that aberrations that occur on the object side surface can be suppressed and favorable optical performance can be obtained.

Further, the second lens L2 has a meniscus shape being convex toward the object side. Therefore, the principal point distance can be made shorter than that in a case where the second lens L2 is a biconvex lens. Further, the power of the combined system of the first lens L1 and the second lens L2 becomes small, and aberrations that occur on the first lens L1 and the second lens L2 can be made small.

Further, the fifth lens L5 is a biconvex lens. Therefore, the power of the fifth lens L5 can be made relatively strong, and chromatic aberration and the like can be effectively corrected.

Further, the sixth lens L6 has, at least on its image side surface, an extreme value other than an intersection point with the optical axis Ax. Therefore, the CRA (chief ray angle) can be made to correspond to the imaging element 51 while the optical performance is maintained.

Further, by the power arrangement (negative, positive, positive, negative, positive, positive or negative) of the first to sixth lenses L1 to L6, various aberrations can be adjusted in a well-balanced manner and the optical performance can be improved.

Further, the imaging optical system 10 satisfies the above conditional expression (1), which is about f2/f. Hence, the refractive power of the second lens L2 can be suitably set. Therefore, it is possible to, while maintaining a small F-number and a wide angle of view, suppress various aberrations that occur on the second lens L2, deterioration of the optical performance, and increase in size of the imaging optical system 10.

Therefore, it is possible to achieve high optical performance and small dimensions while maintaining a small F-number and a wide angle of view.

In the above, embodiments of the present invention has been described. However, embodiments to which the present invention can be applied are not limited to the above-described embodiments and its modification examples, and hence can be appropriately modified without departing from the scope of the present invention.

### EXAMPLES

Examples of the imaging optical system of one or more embodiments of the present invention are shown below. Symbols used in Examples are as follows.
f: Focal Length of Entire Imaging Optical System
F: F-number 2ω: Entire Angle of View
TTL: Total Track Length (Length from Most Convex Point (Vertex) of Lens Surface on Object Side of First Lens to Imaging Element)
R: Curvature Radius
D: On-axis Surface Distance
Nd: Refractive Index of Lens Material with respect to d Line
vd: Abbe Number of Lens Material

In Examples, surfaces with “*” after their surface numbers of lens surface data shown in Tables below are surfaces having an aspheric shape. The shape of an aspheric surface is expressed with the vertex of a surface being the origin, the X-axis being the optical axis direction, and the height in the direction perpendicular to the optical axis being h, and expressed by Formula 1 below.

$$X = \frac{{h}^{2} / R}{1 + \sqrt{1 - ( 1 + K ) {h}^{2} / {R}^{2}}} + \sum {A}_{i} {h}^{i} \qquad [ Formula 1 ]$$

where A, represents an i^{th} order aspheric coefficient, R represents a curvature radius, and K represents a conic constant.

### Example 1

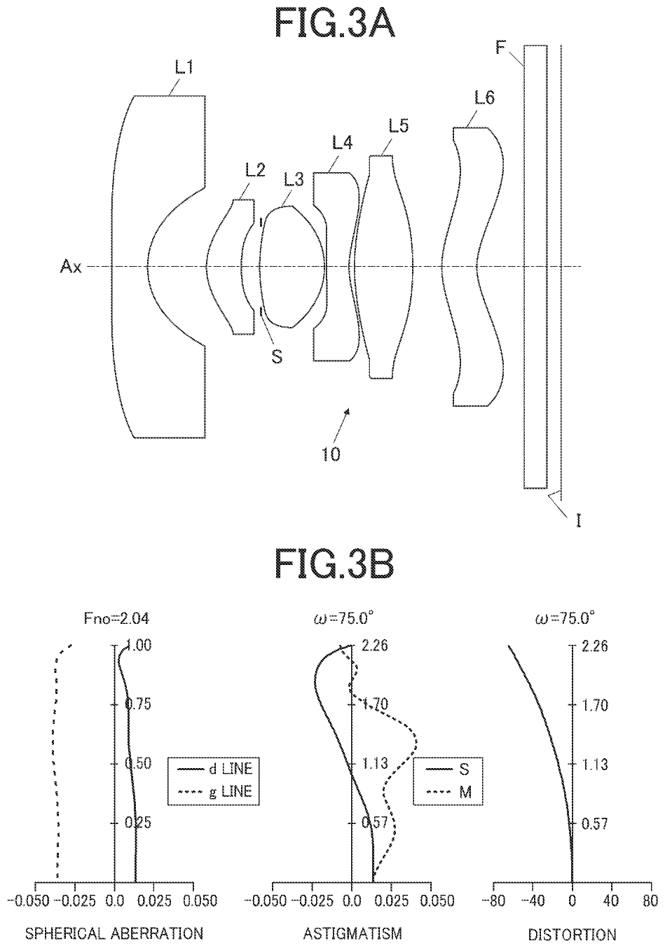

FIG. 3A and FIG. 3B show a sectional view and longitudinal aberrations (spherical aberration, astigmatism and distortion) of the imaging optical system of Example 1.

Overall specifications of the imaging optical system of Example 1 are shown below.
f=1.73 mm
F=2.04
2ω=150.0°
TTL=5.9 mm

Data on the lens surfaces of Example 1 is shown in Table 1 below.

TABLE 1

| SURFACE NUMBER | R (mm) | D (mm) | Nd | νd |
|---|---|---|---|---|
| 1* | 2580.0787 | 0.48 | 1.53504 | 55.7 |
| 2 | 1.108932 | 0.80 | | |
| 3* | 1.1926927 | 0.46 | 1.66100 | 21.3 |
| 4* | 1.8032878 | 0.26 | | |
| 5 (STOP) | 1.02E+18 | −0.01 | | |
| 6* | 4.3824659 | 0.86 | 1.53504 | 55.7 |
| 7* | −1.067065 | 0.03 | | |
| 8* | 11.56849 | 0.30 | 1.66100 | 21.3 |
| 9* | 1.6973581 | 0.07 | | |
| 10* | 5.1161978 | 0.78 | 1.53504 | 55.7 |
| 11* | −3.665262 | 0.38 | | |
| 12* | 1.4459061 | 0.47 | 1.53504 | 55.7 |
| 13* | 1.1591615 | 0.63 | | |

Aspheric coefficients of the lens surfaces of Example 1 are shown in Table 2 below. Hereinafter (lens data in Tables included), a power of 10 may be expressed by using “E”. For example, “2.5×10⁻²” is expressed by “2.5E-02”.

TABLE 2

| | | |
|---|---|---|
| 1^{st} SURFACE | K= | 0 |
| | A4= | −0.00242742 |
| | A6= | 0.009545748 |
| | A8= | −0.00404049 |
| | A10= | 0.000952315 |
| | A12= | −0.00013147 |
| | A14= | 9.85E−06 |
| | A16= | −3.09E−07 |
| 2^{nd} SURFACE | K= | −1.09079061 |
| | A4= | 0.034566562 |
| | A6= | −0.04591726 |
| | A8= | 0.108052258 |
| | A10= | −0.02438065 |
| | A12= | −0.08046088 |
| | A14= | 0.08132455 |
| | A16= | −0.02355121 |
| 3^{rd} SURFACE | K= | −0.21268048 |
| | A4= | −0.02145139 |
| | A6= | −0.09425657 |
| | A8= | 0.129056979 |
| | A10= | −0.29299395 |
| | A12= | 0.127525581 |
| | A14= | 0 |
| | A16= | 0 |
| 4^{th} SURFACE | K= | 2.321884228 |
| | A4= | 0.122436352 |
| | A6= | −0.45440473 |
| | A8= | 2.495283657 |
| | A10= | −6.45936837 |
| | A12= | 6.720748904 |
| | A14= | 0 |
| | A16= | 0 |
| 6^{th} SURFACE | K= | 15.9679931 |
| | A4= | 0.039698746 |
| | A6= | −0.16866858 |
| | A8= | 0.572595159 |
| | A10= | −0.50837093 |
| | A12= | −1.35457263 |
| | A14= | 2.377342084 |
| | A16= | 0 |
| 7^{th} SURFACE | K= | −0.47440706 |
| | A4= | 0.13537278 |
| | A6= | −0.21215528 |
| | A8= | 0.075701707 |
| | A10= | −0.09019501 |
| | A12= | −0.10463828 |
| | A14= | 0.246174201 |
| | A16= | 0 |
| 8^{th} SURFACE | K= | 0 |
| | A4= | −0.3034561 |
| | A6= | 0.475277279 |
| | A8= | −0.76261923 |
| | A10= | 0.288417262 |
| | A12= | 0.163636697 |
| | A14= | −0.23710317 |
| | A16= | 0 |
| 9^{th} SURFACE | K= | −15.4288732 |
| | A4= | −0.06472756 |
| | A6= | 0.07007514 |
| | A8= | −0.0344727 |
| | A10= | −0.03355805 |
| | A12= | 0.029103243 |
| | A14= | −0.00645211 |
| | A16= | 0 |
| 10^{th} SURFACE | K= | −53.3101441 |
| | A4= | 0.136143101 |
| | A6= | −0.31002606 |
| | A8= | 0.444635064 |
| | A10= | −0.37736957 |
| | A12= | 0.185063521 |
| | A14= | −0.04832812 |
| | A16= | 0.005147943 |
| 11^{th} SURFACE | K= | −11.5321884 |
| | A4= | −0.03377538 |
| | A6= | 0.07673631 |
| | A8= | −0.06679749 |
| | A10= | −0.01696666 |
| | A12= | 0.045036587 |
| | A14= | −0.01890159 |
| | A16= | 0.00249193 |
| 12^{th} SURFACE | K= | −0.6669685 |
| | A4= | −0.29657584 |
| | A6= | 0.206260512 |
| | A8= | −0.11441985 |
| | A10= | 0.04277499 |
| | A12= | −0.01066955 |
| | A14= | 0.001544403 |
| | A16= | −9.39E−05 |
| 13^{th} SURFACE | K= | −0.73733527 |
| | A4= | −0.33126204 |
| | A6= | 0.198617664 |
| | A8= | −0.10173145 |
| | A10= | 0.035453812 |
| | A12= | −0.00815137 |
| | A14= | 0.001067116 |
| | A16= | −5.98E−05 |

Single lens data of Example 1 is shown in Table 3 below.

TABLE 3

| LENS | START SURFACE | FOCAL LENGTH (mm) |
|---|---|---|
| 1 | 1 | −2.07 |
| 2 | 3 | 4.07 |
| 3 | 6 | 1.69 |
| 4 | 8 | −3.02 |
| 5 | 10 | 4.10 |
| 6 | 12 | −25.78 |

Numerical values of the conditional expressions (1) to (7) in the imaging optical system of Example 1 are shown below.
Conditional Expression (1): f2/f=2.36
Conditional Expression (2): CT5/f=0.45
Conditional Expression (3): f1/f=−1.20
Conditional Expression (4): f5/f=2.38
Conditional Expression (5): r3/r4=0.66
Conditional Expression (6): r10/f=−2.12
Conditional Expression (7): v3−v4=34.37

### Example 2

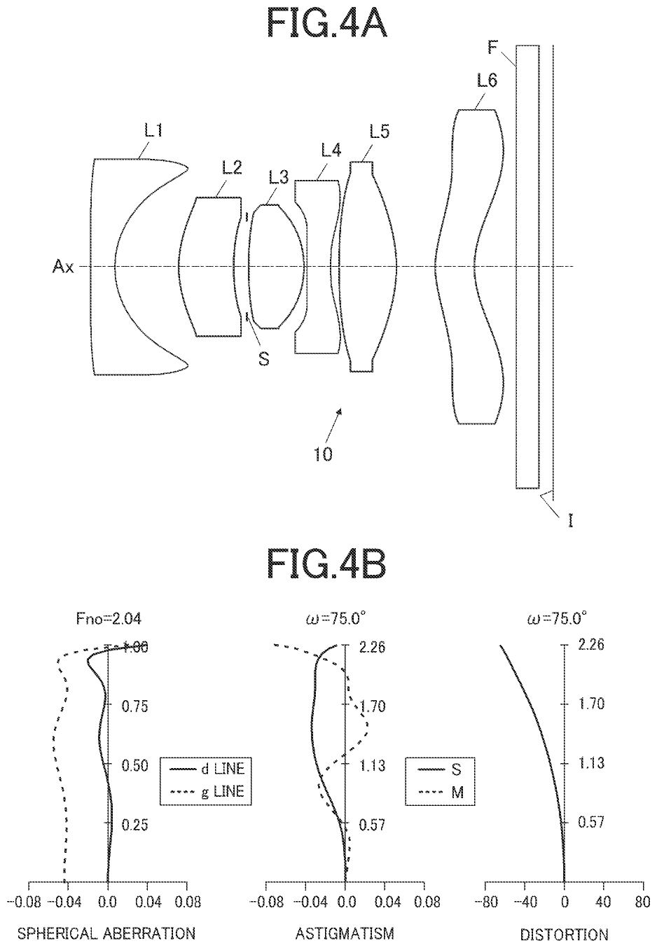

FIG. 4A and FIG. 4B show a sectional view and longitudinal aberrations (spherical aberration, astigmatism and distortion) of the imaging optical system of Example 2.

Overall specifications of the imaging optical system of Example 2 are shown below.
f=1.73 mm
F=2.04
2ω=150.0°
TTL=5.8 mm

Data on the lens surfaces of Example 2 is shown in Table 4 below.

TABLE 4

| SURFACE NUMBER | R (mm) | D (mm) | Nd | νd |
|---|---|---|---|---|
| 1* | 10000 | 0.30 | 1.53504 | 55.7 |
| 2 | 1.0900833 | 0.83 | | |
| 3* | 1.4523543 | 0.72 | 1.65100 | 21.5 |
| 4* | 2.8162231 | 0.18 | | |
| 5 (STOP) | 1.02E+18 | 0.01 | | |
| 6* | 4.89748589 | 0.72 | 1.53504 | 55.7 |
| 7* | −1.061015 | 0.03 | | |
| 8* | 8.4907025 | 0.30 | 1.66100 | 21.3 |
| 9* | 1.5657104 | 0.12 | | |
| 10* | 10.804379 | 0.75 | 1.53504 | 55.7 |
| 11* | −2.517102 | 0.50 | | |
| 12* | 1.5653394 | 0.50 | 1.53504 | 55.7 |
| 13* | 1.1661707 | 0.55 | | |

Aspheric coefficients of the lens surfaces of Example 2 are shown in Table 5 below.

TABLE 5

| | | |
|---|---|---|
| 1^{st} SURFACE | K= | 0 |
| | A4= | 0.393974518 |
| | A6= | −0.03690375 |
| | A8= | −0.02156268 |
| | A10= | 0.00070405 |
| | A12= | −0.00777927 |
| | A14= | −0.001566 |
| | A16= | −0.00180962 |
| 2^{nd} SURFACE | K= | −1.08511998 |
| | A4= | 0.031880318 |
| | A6= | −0.05506238 |
| | A8= | 0.113693925 |
| | A10= | −0.02565916 |
| | A12= | −0.08046088 |
| | A14= | 0.08132455 |
| | A16= | −0.02355121 |
| 3^{rd} SURFACE | K= | −0.25737498 |
| | A4= | −0.0956141 |
| | A6= | −0.00784549 |
| | A8= | 0.000414932 |
| | A10= | 0.000294061 |
| | A12= | −6.7057E−05 |
| | A14= | 0 |
| | A16= | 0 |
| 4^{th} SURFACE | K= | −0.73332385 |
| | A4= | 0.013849339 |
| | A6= | 0.004301036 |
| | A8= | 0.002491363 |
| | A10= | 0.000752775 |
| | A12= | 0.000338081 |
| | A14= | 0 |
| | A16= | 0 |
| 6^{th} SURFACE | K= | 14.38061683 |
| | A4= | 0.001443764 |
| | A6= | 0.000119971 |
| | A8= | 0.000288209 |
| | A10= | 7.25705E−05 |
| | A12= | −2.6036E−05 |
| | A14= | 1.15076E−05 |
| | A16= | 0 |
| 7^{th} SURFACE | K= | −0.60973E+00 |
| | A4= | 0.20923E−01 |
| | A6= | −0.95888E−02 |
| | A8= | 0.56649E−02 |
| | A10= | 0.59833E−03 |
| | A12= | 0.87891E−03 |
| | A14= | 0.74953E−04 |
| | A16= | 0.00000E+00 |
| 8^{th} SURFACE | K= | 0 |
| | A4= | −0.18731381 |
| | A6= | −0.01816674 |
| | A8= | 0.002085001 |
| | A10= | −0.00035265 |
| | A12= | 0.000706661 |
| | A14= | −0.0002929 |
| | A16= | 0 |
| 9^{th} SURFACE | K= | −14.704445 |
| | A4= | −0.10789532 |
| | A6= | −0.02515989 |
| | A8= | 0.000499958 |
| | A10= | −0.00250383 |
| | A12= | 0.000447355 |
| | A14= | −0.000624 |
| | A16= | 0 |
| 10^{th} SURFACE | K= | −35.6048477 |
| | A4= | 0.082630439 |
| | A6= | −0.01320302 |
| | A8= | −0.00062313 |
| | A10= | −0.00335456 |
| | A12= | −0.00125442 |
| | A14= | −0.00105968 |
| | A16= | −0.00026841 |
| 11^{th} SURFACE | K= | −4.04272691 |
| | A4= | −0.02516081 |
| | A6= | 0.061622118 |
| | A8= | 0.006272709 |
| | A10= | −0.00437964 |
| | A12= | −0.00441623 |
| | A14= | −0.0002118 |
| | A16= | 0.000277271 |
| 12^{th} SURFACE | K= | −0.54322036 |
| | A4= | −1.55439595 |
| | A6= | 0.180017323 |
| | A8= | −0.04570088 |
| | A10= | 0.014991565 |
| | A12= | −0.00712738 |
| | A14= | 0.000666549 |
| | A16= | 0.000258687 |
| 13^{th} SURFACE | K= | 0.73529984 |
| | A4= | −2.71674235 |
| | A6= | 0.12954875 |
| | A8= | −0.0934601 |
| | A10= | 0.018190227 |
| | A12= | −0.01389108 |
| | A14= | −0.00263317 |
| | A16= | −0.00119992 |

Single lens data of Example 2 is shown in Table 6 below.

TABLE 6

| LENS | START SURFACE | FOCAL LENGTH (mm) |
|---|---|---|
| 1 | 1 | −2.04 |
| 2 | 3 | 3.84 |
| 3 | 6 | 1.70 |
| 4 | 8 | −2.97 |
| 5 | 10 | 3.90 |
| 6 | 12 | −15.19 |

Numerical values of the conditional expressions (1) to (7) in the imaging optical system of Example 2 are shown below.
Conditional Expression (1): f2/f=2.22
Conditional Expression (2): CT5/f=0.43
Conditional Expression (3): f1/f=−1.18
Conditional Expression (4): f5/f=2.25
Conditional Expression (5): r3/r4=0.52
Conditional Expression (6): r10/f=−1.45
Conditional Expression (7): v3−v4=34.37

### Example 3

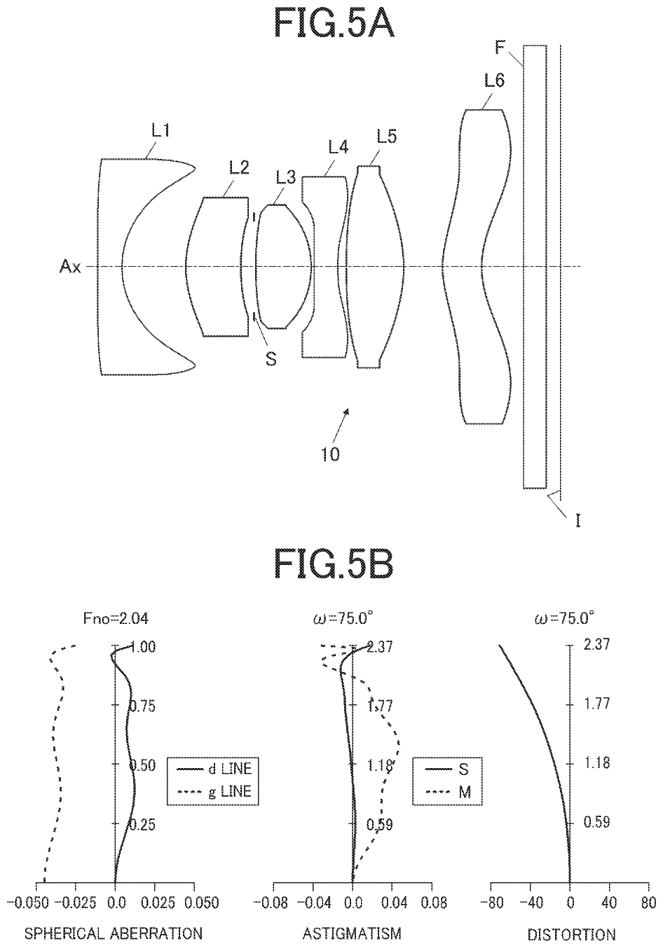

FIG. 5A and FIG. 5B show a sectional view and longitudinal aberrations (spherical aberration, astigmatism and distortion) of the imaging optical system of Example 3.

The overall specifications of the imaging optical system of Example 3 are shown below.
f=1.73 mm
F=2.04
2ω=150.0°
TTL=5.8 mm

Data on the lens surfaces of Example 3 is shown in Table 7 below.

TABLE 7

| SURFACE NUMBER | R (mm) | D (mm) | Nd | νd |
|---|---|---|---|---|
| 1* | 10000 | 0.42 | 1.53504 | 55.7 |
| 2 | 1.1223659 | 0.84 | | |
| 3* | 1.2674305 | 0.52 | 1.65100 | 21.5 |
| 4* | 2.0747341 | 0.24 | | |
| 5 (STOP) | 1.02E+18 | 0.01 | | |
| 6* | 4.6006482 | 0.72 | 1.53504 | 55.7 |
| 7* | −1.100098 | 0.03 | | |
| 8* | 12.986845 | 0.30 | 1.66100 | 21.3 |
| 9* | 1.7397167 | 0.12 | | |
| 10* | 12.405706 | 0.75 | 1.53504 | 55.7 |
| 11* | −2.338837 | 0.39 | | |
| 12* | 1.5614784 | 0.52 | 1.53504 | 55.7 |
| 13* | 1.170936 | 0.64 | | |

Aspheric coefficients of the lens surfaces of Example 3 are shown in Table 8 below.

TABLE 8

| | | |
|---|---|---|
| 1^{st} SURFACE | K= | 0 |
| | A4= | 0.357644071 |
| | A6= | −0.02332452 |
| | A8= | −0.01477712 |
| | A10= | 0.005328196 |
| | A12= | −0.00502852 |
| | A14= | 0.000558512 |
| | A16= | −0.00130312 |
| 2^{nd} SURFACE | K= | −1.15488778 |
| | A4= | 0.031347046 |
| | A6= | −0.04113438 |
| | A8= | 0.116253553 |
| | A10= | −0.03014871 |
| | A12= | −0.08046088 |
| | A14= | 0.08132455 |
| | A16= | −0.02355121 |
| 3^{rd} SURFACE | K= | −0.17215806 |
| | A4= | −0.08689828 |
| | A6= | −0.01441409 |
| | A8= | −0.00179427 |
| | A10= | −2.59E−06 |
| | A12= | −4.46E−05 |
| | A14= | 0 |
| | A16= | 0 |
| 4^{th} SURFACE | K= | 1.20856504 |
| | A4= | 0.017479426 |
| | A6= | 0.001229587 |
| | A8= | 0.001196234 |
| | A10= | 0.000386851 |
| | A12= | 0.000232777 |
| | A14= | 0 |
| | A16= | 0 |
| 6^{th} SURFACE | K= | 6.138776434 |
| | A4= | −0.00036901 |
| | A6= | −0.0012522 |
| | A8= | −2.61E−05 |
| | A10= | −6.86E−05 |
| | A12= | 2.44E−06 |
| | A14= | −1.06E−06 |
| | A16= | 0 |
| 7^{th} SURFACE | K= | −0.40849837 |
| | A4= | 0.011008831 |
| | A6= | −0.01624538 |
| | A8= | 0.000507967 |
| | A10= | −0.00093368 |
| | A12= | 2.97131E−05 |
| | A14= | −0.00012856 |
| | A16= | 0 |
| 8^{th} SURFACE | K= | 0 |
| | A4= | −0.1579378 |
| | A6= | −0.01604397 |
| | A8= | −0.00237027 |
| | A10= | −0.00111463 |
| | A12= | −8.55E−05 |
| | A14= | −0.00024479 |
| | A16= | 0 |
| 9^{th} SURFACE | K= | −15.3203943 |
| | A4= | −0.08447904 |
| | A6= | −0.0107875 |
| | A8= | 0.00048063 |
| | A10= | −0.00068425 |
| | A12= | −1.39E−05 |
| | A14= | −0.00025021 |
| | A16= | 0 |
| 10^{th} SURFACE | K= | −23.4902818 |
| | A4= | 0.0882402 |
| | A6= | −0.01538441 |
| | A8= | 0.001878818 |
| | A10= | −0.0014766 |
| | A12= | −0.00011311 |
| | A14= | −0.00036417 |
| | A16= | −6.22E−05 |
| 11^{th} SURFACE | K= | −6.15069034 |
| | A4= | −0.01357687 |
| | A6= | 0.04017082 |
| | A8= | −0.00174916 |
| | A10= | 6.19E−05 |
| | A12= | −0.00200554 |
| | A14= | 0.00025047 |
| | A16= | 0.000123577 |
| 12^{th} SURFACE | K= | −0.54232092 |
| | A4= | −1.51645424 |
| | A6= | 0.184072467 |
| | A8= | −0.05016377 |
| | A10= | 0.015857068 |
| | A12= | −0.00694098 |
| | A14= | 0.000894519 |
| | A16= | 4.39E−05 |
| 13^{th} SURFACE | K= | −0.73649442 |
| | A4= | −2.70737062 |
| | A6= | 0.159854164 |
| | A8= | −0.08896012 |
| | A10= | 0.022296562 |
| | A12= | −0.01109379 |
| | A14= | −0.00102011 |
| | A16= | −0.00122504 |

Single lens data of Example 3 is shown in Table 9 below.

TABLE 9

| LENS | START SURFACE | FOCAL LENGTH (mm) |
|---|---|---|
| 1 | 1 | −2.10 |
| 2 | 3 | 3.99 |
| 3 | 6 | 1.74 |
| 4 | 8 | −3.07 |
| 5 | 10 | 3.74 |
| 6 | 12 | −16.21 |

Numerical values of the conditional expressions (1) to (7) in the imaging optical system of Example 3 are shown below.
Conditional Expression (1): f2/f=2.30
Conditional Expression (2): CT5/f=0.43
Conditional Expression (3): f1/f=−1.21
Conditional Expression (4): f5/f=2.16
Conditional Expression (5): r3/r4=0.61
Conditional Expression (6): r10/f=−1.35
Conditional Expression (7): v3−v4=34.37

### Example 4

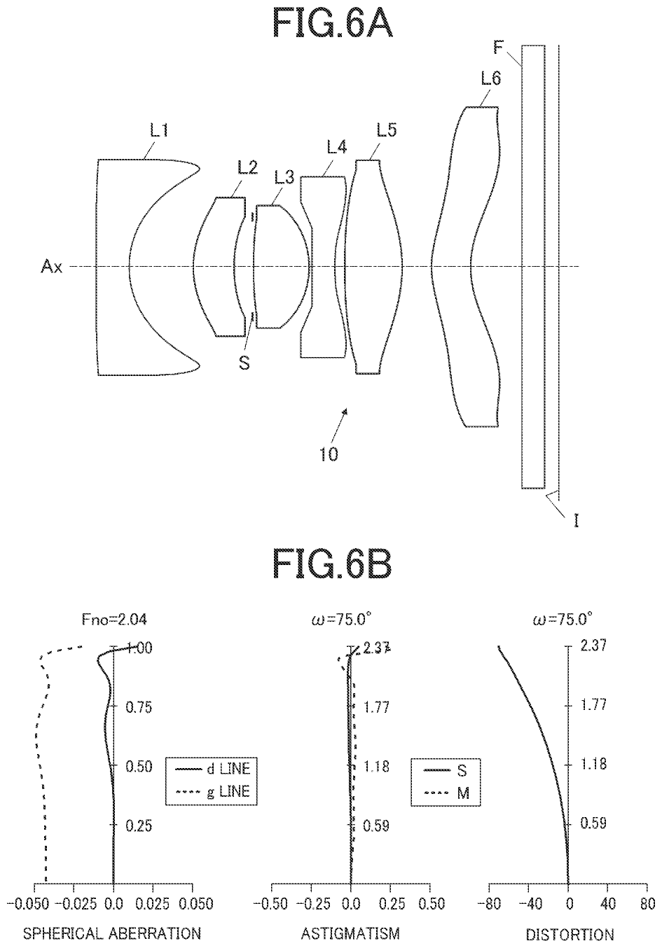

FIG. 6A and FIG. 6B show a sectional view and longitudinal aberrations (spherical aberration, astigmatism and distortion) of the imaging optical system of Example 4.

Overall specifications of the imaging optical system of Example 4 are shown below.
f=1.73 mm
F=2.04
2ω=150.0°
TTL=5.8 mm

Data on the lens surfaces of Example 4 is shown in Table 10 below.

TABLE 10

| SURFACE NUMBER | R (mm) | D (mm) | Nd | νd |
|---|---|---|---|---|
| 1* | 10000 | 0.41 | 1.53504 | 55.7 |
| 2 | 1.1086262 | 0.83 | | |
| 3* | 1.2740841 | 0.53 | 1.65100 | 21.5 |
| 4* | 2.1331468 | 0.24 | | |
| 5 (STOP) | 1.02E+18 | 0.01 | | |
| 6* | 4.8536396 | 0.72 | 1.53504 | 55.7 |
| 7* | −1.072688 | 0.04 | | |
| 8* | 16.710801 | 0.30 | 1.66100 | 21.3 |
| 9* | 1.7183159 | 0.12 | | |
| 10* | 10.840048 | 0.75 | 1.53504 | 55.7 |
| 11* | −2.392496 | 0.39 | | |
| 12* | 1.531843 | 0.52 | 1.53504 | 55.7 |
| 13* | 1.1616288 | 0.64 | | |

Aspheric coefficients of the lens surfaces of Example 4 are shown in Table 11 below.

TABLE 11

| | | |
|---|---|---|
| 1^{st} SURFACE | K= | 0 |
| | A4= | 0.353164874 |
| | A6= | −0.02201199 |
| | A8= | −0.0209059 |
| | A10= | 0.003589651 |
| | A12= | −0.00688606 |
| | A14= | −0.0003549 |
| | A16= | −0.0017433 |
| 2^{nd} SURFACE | K= | −1.18120834 |
| | A4= | 0.027669842 |
| | A6= | −0.04563049 |
| | A8= | 0.115390019 |
| | A10= | −0.02786608 |
| | A12= | −0.08046088 |
| | A14= | 0.08132455 |
| | A16= | −0.02355121 |
| 3^{rd} SURFACE | K= | −0.17178249 |
| | A4= | −0.08845882 |
| | A6= | −0.01223123 |
| | A8= | −0.00125192 |
| | A10= | −9.91E−05 |
| | A12= | −0.00010228 |
| | A14= | 0 |
| | A16= | 0 |
| 4^{th} SURFACE | K= | 1.261603874 |
| | A4= | 0.017808329 |
| | A6= | 0.00207065 |
| | A8= | 0.00145813 |
| | A10= | 0.000415932 |
| | A12= | 0.000231349 |
| | A14= | 0 |
| | A16= | 0 |
| 6^{th} SURFACE | K= | 1.776505856 |
| | A4= | −0.00104734 |
| | A6= | −0.00141319 |
| | A8= | −2.30E−05 |
| | A10= | −9.39E−05 |
| | A12= | 1.98E−05 |
| | A14= | −1.40E−05 |
| | A16= | 0 |
| 7^{th} SURFACE | K= | −0.39063626 |
| | A4= | 0.00982878 |
| | A6= | −0.01664006 |
| | A8= | 4.26424E−05 |
| | A10= | −0.00092788 |
| | A12= | −2.653E−05 |
| | A14= | −0.00015164 |
| | A16= | 0 |
| 8^{th} SURFACE | K= | 0 |
| | A4= | −0.1587176 |
| | A6= | −0.01672472 |
| | A8= | −0.00301287 |
| | A10= | −0.00118401 |
| | A12= | −0.00010263 |
| | A14= | −0.00031264 |
| | A16= | 0 |
| 9^{th} SURFACE | K= | −14.7283254 |
| | A4= | −0.08245009 |
| | A6= | −0.01158722 |
| | A8= | −0.00161748 |
| | A10= | −0.00095065 |
| | A12= | 4.12E−06 |
| | A14= | −0.00031998 |
| | A16= | 0 |
| 10^{th} SURFACE | K= | −13.9149463 |
| | A4= | 0.088078342 |
| | A6= | −0.01724877 |
| | A8= | 0.001777085 |
| | A10= | −0.00284895 |
| | A12= | −0.00022275 |
| | A14= | −0.00057069 |
| | A16= | −0.00025292 |
| 11^{th} SURFACE | K= | −6.61947522 |
| | A4= | −0.01928023 |
| | A6= | 0.038508893 |
| | A8= | 0.000524209 |
| | A10= | −4.52E−05 |
| | A12= | −0.0029069 |
| | A14= | 0.000179457 |
| | A16= | 0.000109516 |
| 12^{th} SURFACE | K= | −0.54709115 |
| | A4= | −1.50757638 |
| | A6= | 0.184972921 |
| | A8= | −0.05082234 |
| | A10= | 0.015149743 |
| | A12= | −0.00790394 |
| | A14= | 0.001234387 |
| | A16= | −0.00010698 |
| 13^{th} SURFACE | K= | −0.73553411 |
| | A4= | −2.70864044 |
| | A6= | 0.168306523 |
| | A8= | −0.09158475 |
| | A10= | 0.017331136 |
| | A12= | −0.01599413 |
| | A14= | −0.00197755 |
| | A16= | −0.00139094 |

Single lens data of Example 4 is shown in Table 12 below.

TABLE 12

| LENS | START SURFACE | FOCAL LENGTH (mm) |
|---|---|---|
| 1 | 1 | −2.07 |
| 2 | 3 | 3.91 |
| 3 | 6 | 1.71 |
| 4 | 8 | −2.92 |
| 5 | 10 | 3.74 |
| 6 | 12 | −17.46 |

Numerical values of the conditional expressions (1) to (7) in the imaging optical system of Example 4 are shown below.
Conditional Expression (1): f2/f=2.26
Conditional Expression (2): CT5/f=0.43
Conditional Expression (3): f1/f=−1.20
Conditional Expression (4): f5/f=2.16
Conditional Expression (5): r3/r4=0.60
Conditional Expression (6): r10/f=−1.38
Conditional Expression (7): v3−v4=34.37

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An imaging optical system comprising:
in order from an object side,
a first lens that has negative power and an object side surface having a convex shape;
a second lens that has positive power and a meniscus shape being convex toward the object side;
a third lens that has positive power;
a fourth lens that has negative power;
a fifth lens that is a biconvex lens having positive power; and
a sixth lens that has positive or negative power, has an image side surface, and has an extreme value other than an intersection point with an optical axis at least on the image side surface of the sixth lens, wherein
the imaging optical system satisfies a following conditional expression (1):
1.5<f2/f<3.5 (1)
where f2 represents a focal length of the second lens, and f represents a focal length of the imaging optical system.

2. The imaging optical system according to claim 1, wherein
the imaging optical system satisfies a following conditional expression (2):
0.35<CT5/f<0.60 (2)
where CT5 represents a center thickness of the fifth lens, and f represents the focal length of the imaging optical system.

3. The imaging optical system according to claim 1, wherein
the imaging optical system satisfies a following conditional expression (3):
−1.25<f1/f<−0.30 (3)
where f1 represents a focal length of the first lens, and f represents the focal length of the imaging optical system.

4. The imaging optical system according to claim 1, wherein
the fifth lens has an image side surface, and
the imaging optical system satisfies a following conditional expression (4):
1.5<f5/f<2.5 (4)
where f5 represents a focal length of the image side surface of the fifth lens, and f represents the focal length of the imaging optical system.

5. The imaging optical system according to claim 1, wherein
the second lens has an object side surface and an image side surface, and
the imaging optical system satisfies a following conditional expression (5):
0.40<r3/r4<0.80 (5)
where r3 represents a curvature radius of the object side surface of the second lens, and r4 represents a curvature radius of the image side surface of the second lens.

6. The imaging optical system according to claim 1, wherein
the fifth lens has an image side surface, and
the imaging optical system satisfies a following conditional expression (6):
−3.0<r10/f<−1.0 (6)
where r10 represents a curvature radius of the image side surface of the fifth lens, and f represents the focal length of the imaging optical system.

7. The imaging optical system according to claim 1, wherein
the imaging optical system satisfies a following conditional expression (7):
v3−v4>30.0 (7)
where v3 represents an Abbe number of the third lens, and v4 represents an Abbe number of the fourth lens.

8. The imaging optical system according to claim 1, wherein each of the third lens and the fourth lens has an object side surface that has a convex shape.

9. A lens unit comprising:
the imaging optical system according to claim 1; and
a lens barrel that holds the imaging optical system.

10. An imaging device comprising:
the lens unit according to claim 9; and
an imaging element that detects an image formed by the imaging optical system.
